(19) United States
(12) Patent Application Publication
(10) Pub. No.: US 2013/0275251 A1
(43) Pub. Date: Oct. 17, 2013

(54) VIDEO GIFT CARD HOLDER AND SYSTEM

(71) Applicant: GIFT CARD IMPRESSIONS, LLC, Kansas City, MO (US)

(72) Inventors: Brett R. Glass, Kansas City, MO (US); Nicole E. Glass, Kansas City, MO (US)

(21) Appl. No.: 13/854,914

(22) Filed: Apr. 1, 2013

Related U.S. Application Data
(60) Provisional application No. 61/618,678, filed on Mar. 31, 2012.

(51) Int. Cl. H04N 5/64

(52) U.S. Cl. CPC H04N 5/64
USPC 705/26.1; 348/836

(57) ABSTRACT

The present disclosure relates to devices and methods for holding and presenting transaction cards, stored value cards, or gift cards along with a video presentation. In particular, the present disclosure relates to a gift card holder that includes a device for storing and playing video files and systems and methods for delivering content to the device via an online transaction.

### CROSS REFERENCE TO RELATED APPLICATIONS

The present application claims priority to U.S. Provisional Patent Application No. 61/618,678, entitled “Video Gift Card Holder and System” and filed on Mar. 31, 2012. The present application is also related to U.S. patent application Ser. No. 13/753,453, entitled “Personalized Webpage Gifting System” and filed on Jan. 29, 2013, which claims priority to U.S. Provisional Patent Application No. 61/592,320 filed Jan. 30, 2012, U.S. Provisional Patent Application No. 61/698,410 filed Sep. 7, 2012, and U.S. Provisional Patent Application No. 61/737,729, filed Dec. 14, 2012. Each of the above-listed patent applications is incorporated herein by reference in their entirety.

### FIELD OF THE PRESENT DISCLOSURE

The present disclosure relates to devices and methods for holding and presenting transaction cards, stored value cards, or gift cards along with a video presentation. In particular, the present disclosure relates to a gift card holder that includes a device for storing and playing video files and systems and methods for delivering content to the device via an online transaction.

### BACKGROUND OF THE PRESENT DISCLOSURE

Transaction cards, stored value cards, or gift cards, as they are commonly called based upon their intended use, have become popular gifts. Gift cards typically comprise a stored value card whereby a certain cash equivalent value is encoded upon a magnet strip applied to the surface of the card. This stored value may be determined by the vendor prior to packaging and display for sale or, more commonly, is selected at the point of sale by the purchaser and loaded by the cashier using a magnet card reader/writer. While popular, gift cards are typically provided with a generic and impersonal design, typically identifying the associated merchant for which the card may be used to purchase merchandise, and therefore are not personalized in view of the intended recipient.

What is needed, therefore, is a device that increases the perceived value of a gift comprising a gift card and enhances the gift selection, presentation, and receiving experience for the gift giver and recipient.

### SUMMARY OF THE PRESENT DISCLOSURE

The present disclosure generally relates to a holder for holding transaction cards, such as gift cards, in a device capable of video playback. The device may store video files as well as presenting a removable gift card. Embodiments of the invention include methods and means for uploading and delivering video content to the device via online transactions.

In one embodiment, a gift card holder device includes a main body defining an interior chamber and a video player housed within the interior chamber. The device also includes a power source housed within the interior chamber and a communication port within the main body. The communication port is in electrical communication with the video player. In various embodiments, the device is configured to receive one or more gift cards using an adhesive, an envelope, a flap, or slots formed in the main body to engage the gift cards. The device may include a cover portion that is engaged to the main body.

Methods to purchase and/or personalize the video gift card holder are also disclosed herein. In one embodiment, a method of personalizing a video gift card holder includes connecting the video gift card holder to a computing device, transferring a data file to the data storage medium from the computing device, and disconnecting the video gift card holder from the computing device. The data file may include a video, audio or still images.

In another embodiment, a method of personalizing a video gift card holder includes accessing an online portal and inputting data into an interface of the online portal. The data may identify at least one of a gift recipient, an occasion, or a gift giver, among others. The method also includes a selecting at least one data file to be stored on the video gift card holder, selecting a gift card to be attached to the video gift card holder, and selecting a monetary value for the gift card.

Other advantages of the invention will become apparent from the following description taken in connection with the accompanying drawings, wherein is set forth by way of illustration and example an embodiment of the present invention.

### BRIEF DESCRIPTION OF THE DRAWINGS

FIG. 1 is a perspective view of the front of a video gift card holder according to one embodiment.

FIG. 2 is a front elevation view of a video gift card holder according to one embodiment.

FIG. 3 is a cross-sectional view of the video gift card holder in FIGS. 1 and 2 as viewed along section line A-A

FIG. 4 is a rear elevation view of a video gift card holder according to one embodiment.

FIG. 5 is a bottom elevation view of a video gift card holder according to one embodiment.

FIG. 6 is a front elevation view of a video gift card holder with an attached gift card according to one embodiment.

FIG. 7 is an elevation view of a video gift card holder with the cover opened according to one embodiment.

FIG. 8 is a front, top perspective view of a video gift card holder with the cover opened according to one embodiment.

FIG. 9 is a perspective view of the front of a video photographic album according to one embodiment.

FIG. 10 is a perspective view of the front of a case for a video photographic album according to one embodiment.

FIG. 11 is a front elevation view of a video photographic album partially removed from an associated case according to one embodiment.

FIG. 12 is an elevation view of a video photographic album with the cover opened according to one embodiment.

FIG. 13 is flowchart depicting one method of personalizing a video gift card holder according to one embodiment.

FIG. 14 is flowchart depicting one method of personalizing a video gift card holder according to one embodiment.

### DETAILED DESCRIPTION

The present disclosure generally relates to a video gift card holder for holding a transaction cards, stored value cards, or gift cards and presenting the gift card to a recipient along with a video presentation. The terms “transaction card”, “stored value card”, and “gift card” may be used interchangeably and each may be referred to herein as a gift card. In various embodiments, the gift card holder includes a video player for displaying data stored on a data storage device within the gift card holder. The present disclosure also relates to systems and methods for storing data on the data storage device to further customize the presentation of the gift card.

It should be understood that the disclosed embodiments are merely exemplary of the invention, which may be embodied in various forms. Therefore, specific structural and functional details disclosed herein are not necessarily to be interpreted as limiting, but merely as a basis for the claims and as a representative basis for teaching one skilled in the art to variously employ the present invention in virtually any appropriately detailed structure.

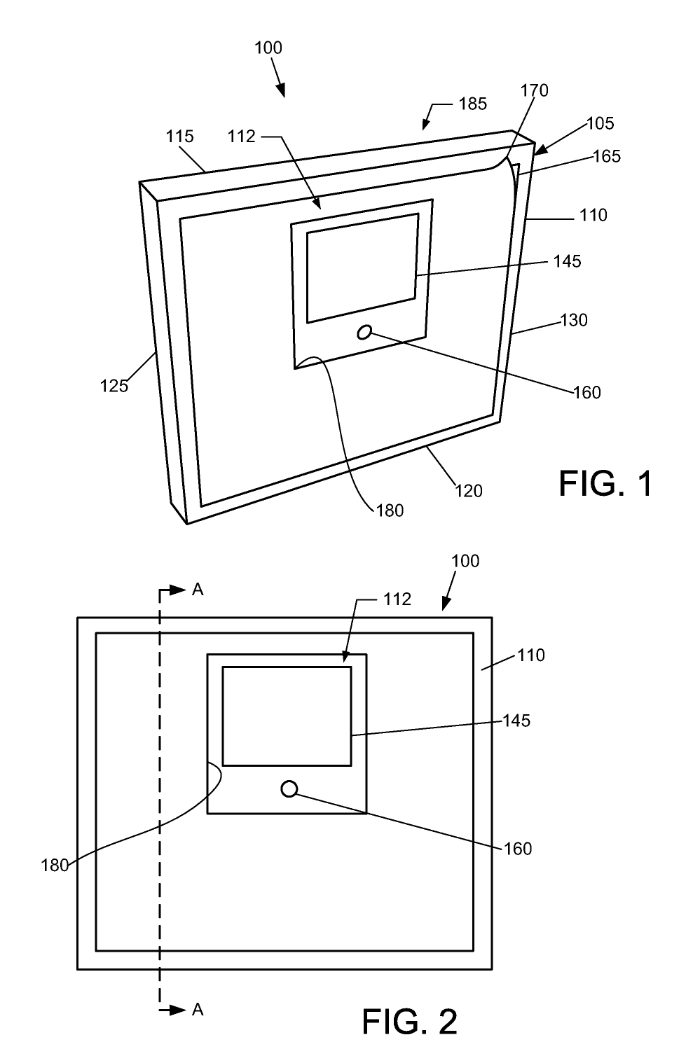

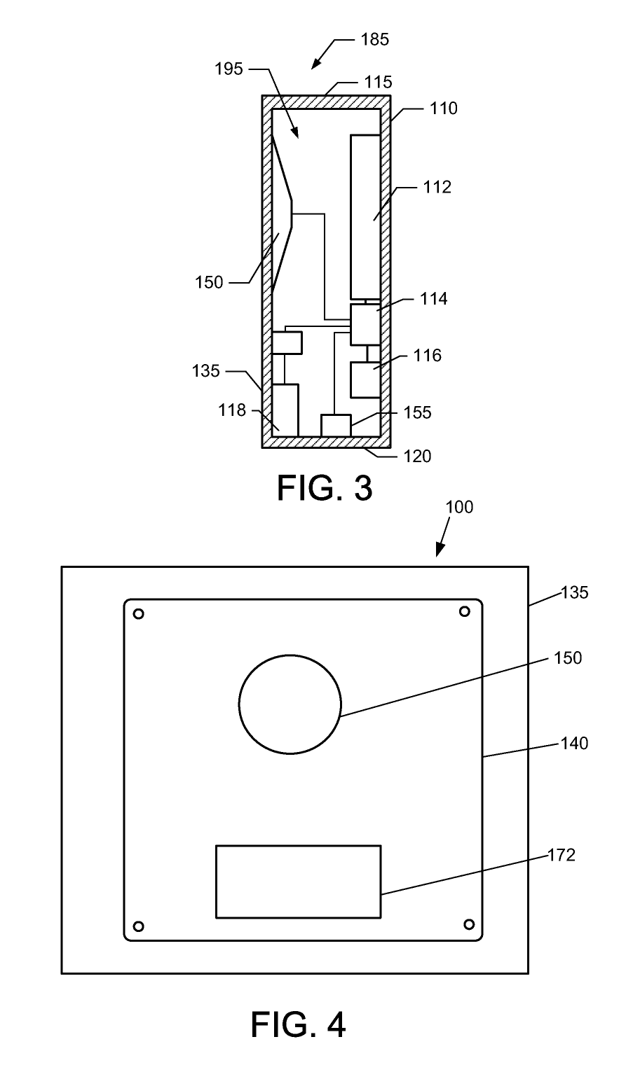

One embodiment of the video gift card holder 100 is shown in FIGS. 1-6. In particular, FIG. 1 is a perspective view of the front of the video gift card holder 100, while FIG. 2 is a front elevation view of the video gift card holder. The video gift card holder 100 includes a main body 105 that includes a front wall 110, opposing top and bottom walls 115 and 120, respectively, and opposing first and second side walls, 125 and 130 respectively. In one aspect, the top wall 115, bottom wall 120 and side walls 125 and 130 are contiguous with the front wall 110. The walls 110, 115, 120, 125, and 130 define a video player housing 185 that includes a hollow interior chamber 195, as shown in FIG. 3. A back wall 135 forms a closure of the chamber 195 and is typically of similar dimensions to the front wall 110. The back wall 135 may include a smaller back panel 140 that provides access to electrical components of a video player 112 housed within the interior chamber 195 of the main body 105.

The walls 110, 115, 120, 125, and 130 of the video gift card holder 100 may be made of paper stock, card stock, chipboard, or pasteboard. In other embodiments, the walls 110, 115, 120, 125, and 130 may be made of plastics and other rigid materials.

In various embodiments, the video player 112 may be any device suitable for video file storage and playback, such as an MP3 player or the like, that may be positioned within the interior chamber 195. In one embodiment, the video player 112 includes a processor 114 in communication with rewritable data storage medium 116 to store one or more video files. In various embodiments, the data storage medium 116 may be any database, hard drive, flash drive, or other non-transitory data storage device or structure. In one embodiment, the data storage medium 116 is a persistent random access memory (RAM) that stores data uploaded to the holder device 100, provides a buffer for the processor 114, and may store a software application executable by the processor. In one aspect, the persistent RAM is immune to power losses at the processor 114. In another embodiment, the data storage medium 116 is readable only and may not be altered. The player 112 also includes a display device or screen 145 that is in communication with the processor 114. By way of example and not limitation, the display device 145 may include an LED or LCD screen for displaying the video files or other images stored on the data storage medium 116.

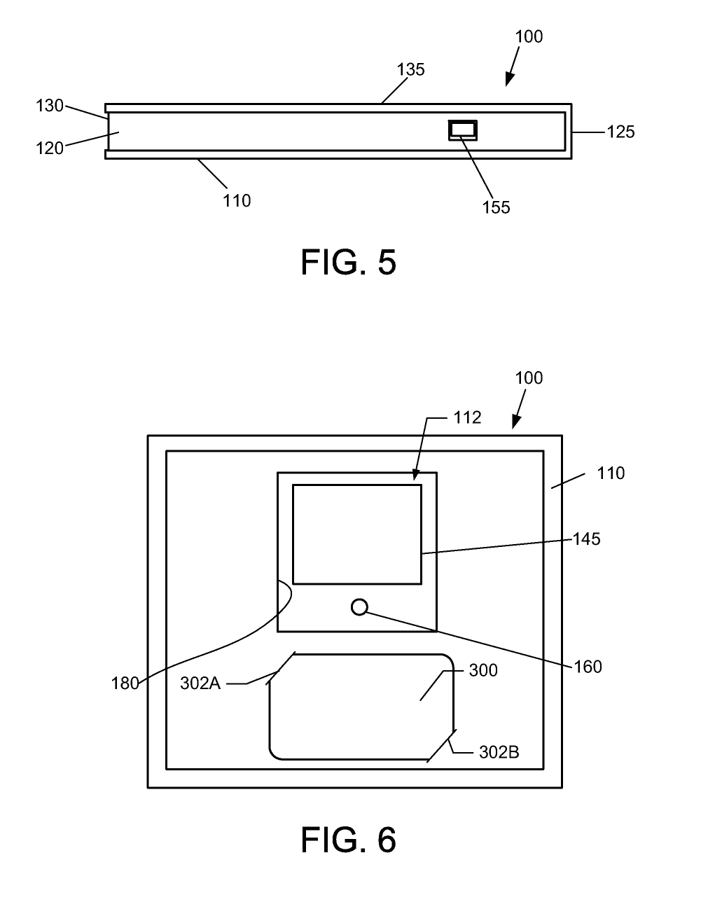

The video player 112 also includes one or more speakers 150 that is in communication with the processor 114 for producing audible sound based on the data stored on the data storage medium 116 and one or more communication port 155 or other electrical connector, such as a USB port as shown in FIG. 5, to permit electrical communication between the video player 112 and a computing device or other data source external to the gift card holder 100.

The video player 112 is in electrical communication with a power source 118, including but not limited to one or more batteries. The power source 118 may be in communication with the video player 112 through a power switch 122 for controlling the flow of electricity from the power source to the video player. The video player also includes one or more playback switches 160 (playback button) for initiating playback of a video file. The various components of the video player 112 may be in communication through electrical circuitry as known in the art for electrical communication to transmit power from the power source, receiving a video file from a PC or other source and storing the file in memory, and, upon activating the playback switch, retrieving video image signals and audio signals from a video file stored in memory and passing video image signals to the screen and associated processors and circuits and audio signals to the speaker 150 and associated processors and circuits.

A rear elevation view of the video gift card holder 100, as shown in FIG. 4, illustrates an embodiment of the back wall 135 that includes a back panel 140 that includes cutouts or apertures for the speaker 150 and power source access, such as a battery compartment door 172.

In various embodiments, the walls 110, 115, 120, and 135 may include indicia, including but not limited to decorations, graphics, images, text, or the like. The indicia may be selected based upon the occasion for gift giving. For example, the appropriate indicia for birthdays, anniversaries, or any other event may be selected. In addition, the indicia may be selected based upon seasonal or holiday occasions. In certain embodiments, the front wall 110 is provided with an adhesive sheet 165 that is adhered all or part of the surface of front wall 110. The back surface of the adhesive sheet 165 is adhered to the front wall 110. Typically, the front surface of the adhesive sheet 165 provided and covered with a protective sheet 170 that covers and protects it until an image sheet (not shown) is prepared to adhere to the front surface of the adhesive sheet 165. At such time, the protective sheet 170 peeled off or otherwise removed and the image sheet is pressed onto the exposed adhesive. The image sheet may be prepared and adhered by an end user or by a product fulfillment center or the like.

In various embodiments, one or more gift card(s) 300 may be removably attached to the holder 100 prior to giving the holder 100 to a gift recipient. In one aspect, the gift card 300 may be attached to any of the walls 110, 115, 120, or 135 via a removable adhesive, an envelope or flap affixed to the walls, or one or more slots 302A-B formed into the walls to receive one or more corners of the gift card, as shown in FIG. 6.

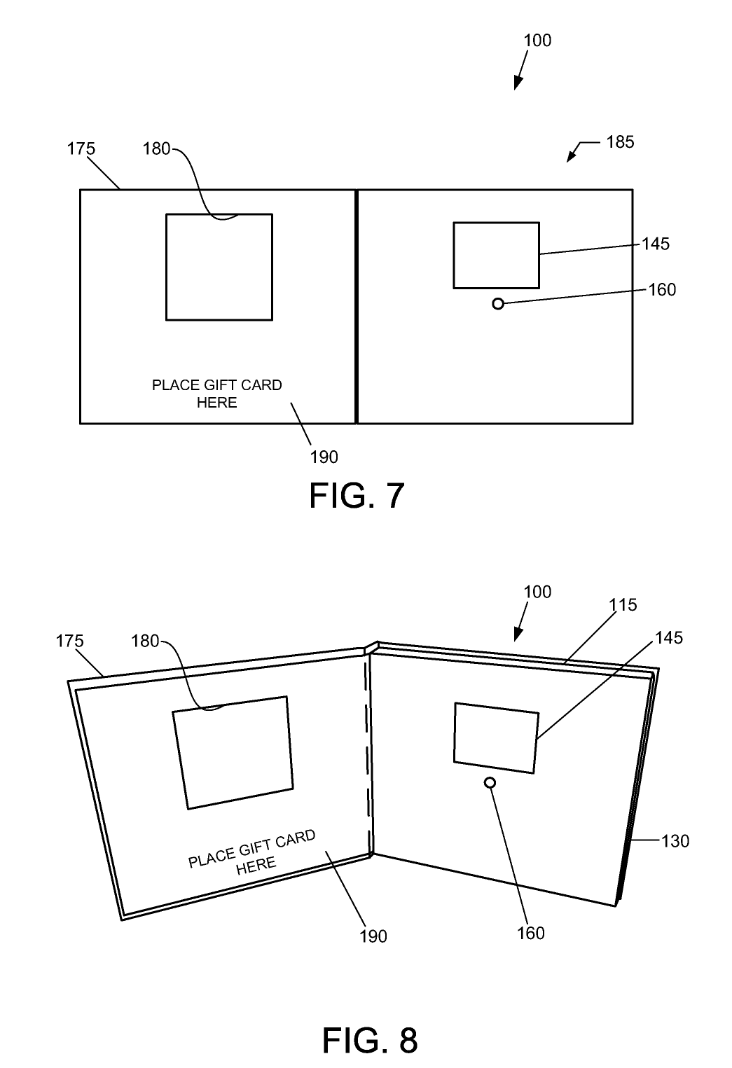

In another embodiment of the video gift card holder 100, as shown in FIGS. 7-8, a cover 175 portion is hingedly connected to the video player housing 185. The cover portion 175 may be pivoted away from the video player housing 185 to open in a manner similar to a book, as shown in FIG. 8. Similar to the walls 110, 115, 120, 125, and 130, the cover portion 175 may be made of paper stock, card stock, chipboard, pasteboard, plastics, or other materials.

As shown, the cover portion 175 includes a window or aperture 180 so that the screen 145 may be viewed through the cover portion when the video card holder is in a closed configuration. Also shown, is gift card attachment position 190 on the inside of the cover 174 where a gift card may be removably attached to the holder 100 prior to giving the holder 100 and attached gift card to a gift recipient. The gift card may be attached to the inside surface of the cover 175 at the position 190 via removable adhesive, slots, similar to those shown in FIG. 6, in the inside cover surface or by other operable means.

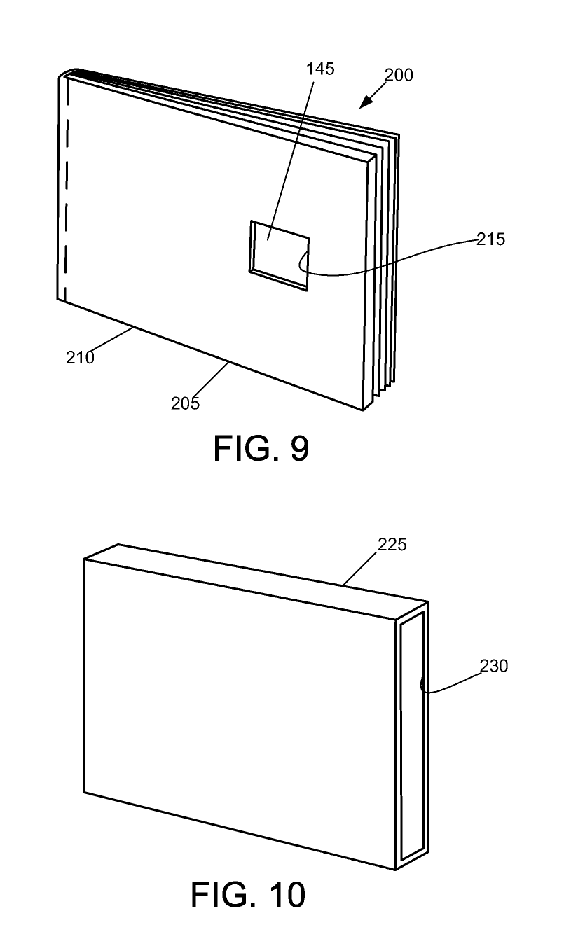

FIGS. 9-12 illustrate other features embodiments of a video gift card holder that is configured to include a video photographic album 200. In one aspect, the video photographic album 200, shown in FIG. 9 may be placed with in a case 205, shown in FIG. 10. for a video photographic album 200. In one aspect, the video photographic album 200 includes many of the same elements and features previously with reference to the video gift card holder 100. As shown the video photographic album 200 includes a main body 205 that is contiguous with a front cover 210. A window or aperture 215 is cut or otherwise formed in the front cover 210 and is aligned with the screen 145 of the video player 112 so that the screen may be viewed through the cover 210. The video photographic album 200 may include one or more photograph display pages that may be printed with or otherwise displaying photographs or other images 220, as shown in FIG. 12.

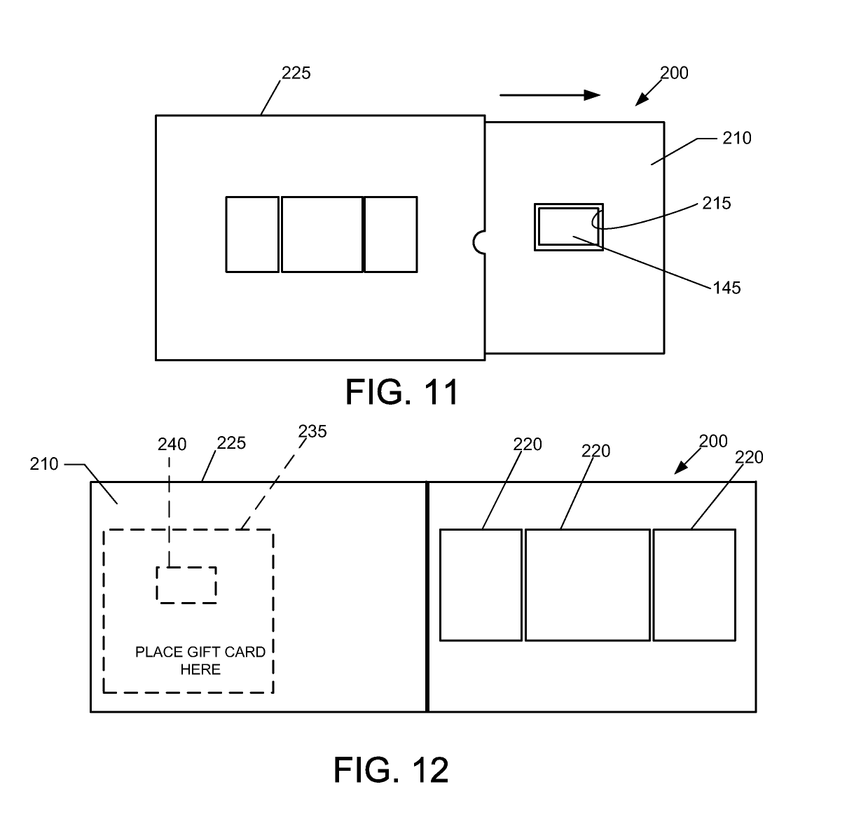

The case 225 is configured for holding or retaining the album 200 and protecting it during storage or transport. Preferably, the case 225 is composed of a sturdy material, including but not limited to cardboard, thick cardstock, plastic or other packaging material. In one embodiment, the case 225 includes five walls that define an opening 230 to enclose and surround an inserted album 200. FIG. 11 is a front elevation view of a video photographic album 200 partially removed from the associated case 225. FIG. 12 is an elevation view of a video photographic album 200 with the cover 210 opened. Phantom lines 235 show the outline of video playback device held within the cover 210 and phantom lines 240 show the outline of the device's screen, observable from the other side (front side) of the cover 210.

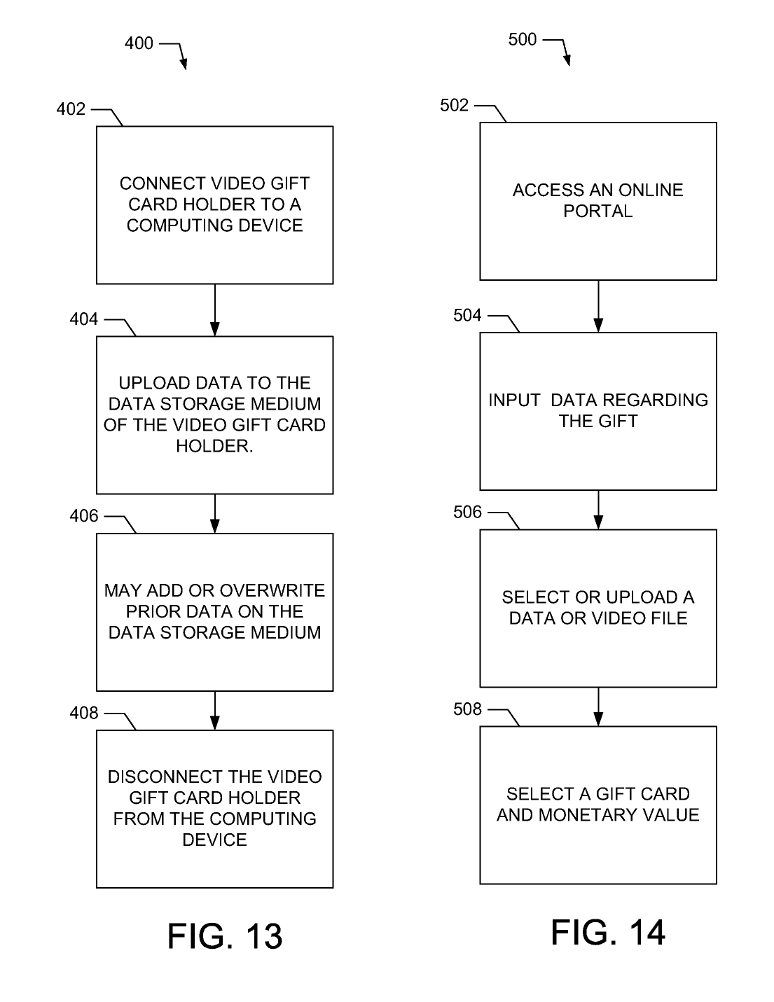

FIG. 13 is a flowchart depicting a method 400 for customizing the content of the video gift card holder 100 or 200. At 402, the video gift card holder 100 is connected to a computing device, including but not limited to a smartphone, PDA, personal computer, or tablet, through a USB cable or similar means inserted into the communication port 155. At 404, data, including the video file to be displayed is uploaded to the data storage medium 116 of the video gift card holder 100 or 200. At 406, a user may add to or overwrite prior data and video files on the data storage medium 116, while at 408, the video gift card holder 100 or 200 is disconnected from the computing device. After uploading data, the holder 100 or 200 may then be presented to the gift recipient, who may then view and share the video.

In various other embodiments, video files may also be provided by the gift giver or givers, or other participants, via an online transaction. Video files uploaded or recorded on a computing device, such as a PC, are then transferred or copied via an online portal to a fulfillment center, which stores the video file, or portions thereof onto a selected holder 100 or album 200.

For example an online portal, such as that disclosed and claimed in co-pending, co-owned U.S. patent application Ser. No. 13/753,453, entitled “Personalized Webpage Gifting System,” and filed on Jan. 29, 2013, which has been incorporated herein in its entirety by reference, may be used to order and personalize a video gift card holder 100 or album 200. In one aspect, the online portal may include a purchase interface of a system website for receiving initial purchase and personalization information from a purchaser. The purchase interface is typically a web page created using HTML, XML, XHTML, Javascript®, Java® and/or equivalent programming languages or scripts as generally known in the field of art. A user (purchaser) may arrive at the system interface via a link (e.g. html link) provided on a third party website, such as a third party website offering gift cards or other goods or services, or by directly accessing a system provider website. Certain embodiments or components of the purchase interface may be accessible via a browser, mobile Internet application, or other Internet accessible software on a personal computer, smart phone, tablet device, electronic game device, or other electronic device used for Internet access.

The purchase interface allows the purchaser to select among several themes or occasions (such as birthday, anniversary, Christmas, graduation) which will influence or determine the options offered by the system during the transaction. The purchaser is prompted to enter information identifying the purchaser and information identifying the recipient. Such information may include name, address, telephone number and email address. Further information entered for the gift recipient may include gender, age, interests, etc. Interests may include entering or selecting among vendors typically frequented or preferred by the gift recipient. The purchaser is then prompted to select one or more gift cards or other gifting means, select or enter monetary amounts, and provide personalization content such as one or more messages to a gift recipient, photographs or other images, and sound and/or video files.

The purchaser may be presented with a choice to either create a closed gifting presentation, whereby all selections are determined during the purchase process, or to create an open gifting presentation, whereby the purchaser, third parties, and in some embodiments the recipient, may provide subsequent additional content and selections. The system provides personalization choices to the purchaser including delivery of a selected gift card via a holder 100 or 200 customized by inclusion of a selected or purchaser-provided video file.

An email message is generated by the system to the gift recipient and includes a link to a personalized event webpage identified by a personal uniform resource locator (PURL), both created by the system in response to selections and information provided by the purchaser. Typically, the PURL will incorporate some portion of the recipient's name or other personal identifier. In certain instances, the identifier may relate to the name of a company or organization. The personalized event webpage may include information provided by the purchaser such as the recipient's name, images, messages to the recipient, and information regarding gifting. Means may be provided for the recipient to add information to the webpage such as a wish list or a message to third parties that view or interact with the webpage. Means may also be provided for third parties, such as friends, relatives, or coworkers to add information for presentation on the webpage or other use by the system, such as details of an event (e.g. birthday party), messages to the recipient, or photos or video clips of an event. Information generated by the system or provided by the system provider may also be presented on the webpage such as information identifying gifting opportunities for any party interacting with the webpage. Information provided by a gift card vendor or affiliates of the system provider or gift card vendor may also be provided. For example, offers and advertisements generated by or on behalf of the gift card vendor or affiliate may be displayed.

In order to invite third parties to contribute to the content of the personalized webpage and/or to make gift purchase selections, a link incorporating the PURL associated with the webpage may be sent to third parties via email, text message, or similar means. The third party invitation to participate may include graphics and text designed to encourage participation and build excitement. The invitation may be sent well in advance of an alert to the recipient, so that third parties may make contributions and selections to the webpage, as well as gift purchases, prior to presentation of the webpage to the recipient. Alternatively, the recipient may be alerted shortly after creation of the webpage and PURL so that the recipient may also influence content and selections, such as by providing a wish list or other information useful for participants to make gift purchase decisions.

In order to alert the recipient to the personalized webpage, and to provide a link incorporating the PURL associated with the webpage, the system may generate an email or text message to the gift recipient. Alternatively, or in conjunction with the recipient alert message, a video teaser may be created using content provided and selected by the purchaser.

A video teaser is a video file that may be provided in advance of receipt of a gift card by the recipient to communicate a particular sentiment, occasion, or gift card brand experience to the recipient. The video teaser may also be provided to introduce the recipient to a PURL webpage created by the system by order of the purchaser. The video teaser is typically personalized by uploading the recipient's photo to a system central server. Text content can be added to certain customizable text fields such as the recipient's name and the occasion or sentiment. Upon uploading personalized content, the video is then rendered or composited to include the personalized content. The video teaser is sent ahead of the gift card, or used to introduce a PURL webpage, via a link provided by email, text message, or similar means. The recipient selects the link to view the video, which is designed to create excitement, anticipation, and imagination of the possibilities of a special gifting experience.

To select and enable generation of a video teaser, the purchaser first selects a video teaser type from among several prerecorded videos that may be viewed on or from a system interface. Next, the user uploads a photograph of the recipient, enters the recipient's name in a text box, selects an appropriate occasion or sentiment from among several provided by the system, and enters the recipient's email address. In some embodiments, additional text fields may be provided to receive additional user text. The photograph and text are then rendered into the selected video based on pre-defined fields within the video thereby creating an augmented reality experience for the recipient. The user is provided with an option to preview the video and make changes to the user information. When the user is satisfied with the video, it is saved to a central server. Upon completing the transaction via a payment/checkout procedure, a message is sent to the recipient with the link to view the video.

FIG. 14 is a flowchart 500 of another method to purchase and personalize a video gift card holder through an online portal. At 502, a user accesses an online portal and inputs data into an interface of the online portal at 504. In one aspect, the input data may identify a gift recipient, the occasion for the gift, and the gift giver, among other information. At 506, the user selects or uploads at least one data file or video to the portal for subsequent storage on the video gift card holder, and at 508, the user selects the gift card and monetary value of the gift to be attached to the video gift card holder.

As a further alternative that may be used in conjunction with any of the above means of notification, a third party invitation to participate, and/or an alert to the recipient, may be conveyed via social media such as a post to one or more Twitter® or Facebook® accounts. In addition to a link to the PURL webpage, these posts may provide additional information related to the recipient and event and provide a means for coordinating activities related to the event.

As an alternative to email or text messages to convey links, QR codes may be provided on gift cards, gift card holders, inserts, backer panels, correspondence, or other physical items conveyed to the gift recipient. These QR codes may be used as an alternative machine-readable method to encode and convey links or other information relative to the system.

The description above includes examples, page systems, methods, techniques, instruction sequences, and/or computer program products that embody techniques of the present disclosure. However, it is understood that the described disclosure may be practiced without these specific details. In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium (e.g., floppy diskette), optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions.

It is believed that the present disclosure and many of its attendant advantages will be understood by the foregoing description, and it will be apparent that various changes may be made in the form, construction, and arrangement of the components without departing from the disclosed subject matter or without sacrificing all of its material advantages. The form described is merely explanatory, and it is the intention of the following claims to encompass and include such changes.

While the present disclosure and the disclosures of the referenced patent applications, that have been incorporated herein by reference, have been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology.

1. A gift card holder device comprising:
a main body defining an interior chamber;
a video player housed within the interior chamber;
a power source housed within the interior chamber; and
a communication port within the main body, wherein the communication port is in electrical communication with the video player;

2. The device of claim 1 further comprising an adhesive to affix the gift card to the main body.

3. The device of claim 1 further comprising a pocket affixed to the main body to receive the gift card.

4. The device of claim 1 further comprising at least one slot formed in the main body to receive the gift card.

5. The device of claim 1, wherein the video player comprises:
a processor;
a display device;
a speaker device;
memory;
a power switch; and
at least one playback switch.

6. The device of claim 1, wherein the main body comprises:
a front wall;
a back wall;
a top wall;
a bottom wall;
a first sidewall; and
a second sidewall;

7. The device of claim 3, wherein at least one of the front wall, back wall, top wall, bottom wall, first sidewall, and second sidewall comprises at least one indicia.

8. The device of claim 4, wherein the at least one indicia is adhered to the respective wall.

9. The device of claim 3, wherein the back wall comprises a back panel, the back panel further comprising:
a first cutout to receive a speaker; and
a second cutout to access the power source.

10. The device of claim 3, wherein the bottom wall comprises a cutout to access a communications port.

11. A gift card holder device comprising:
a main body defining an interior chamber;
a cover portion hingedly attached to the main body;
a video player housed within the interior chamber;
a power source housed within the interior chamber;
a communication port within the main body, wherein the communication port is in electrical communication with the video player;

12. The gift card device of claim 11 wherein the cover portion comprises a cutout aligned with a display device of the video player, such that the display device may be viewed through the cover portion.

13. The gift card device of claim 11 further comprising at least one photo display page.

14. The gift card device of claim 13, wherein the least one photo display page comprises image.

15. The gift card device of claim 11, further comprising a case for holding the main body.

16. The gift card device of claim 15, wherein the case is configured to protect the main body during storage or transport.

17. A method of personalizing a video gift card holder comprising:
connecting the video gift card holder to a computing device;
transferring a data file to the data storage medium from the computing device; and
disconnecting the video gift card holder from the computing device.

18. The method of claim 17, wherein the data file comprises a video, audio, or still images.

19. A method of personalizing a video gift card holder comprising:
accessing an online portal:
inputting data into an interface of the online portal, wherein the data identifies at least one of a gift recipient, an occasion, or a gift giver;
selecting at least one data file to be stored on the video gift card holder;
selecting a gift card to be attached to the video gift card holder; and
selecting a monetary value for the gift card.

20. The method of claim 19 further comprising selecting a video teaser to associate with the video gift card holder.
